(19) United States
(12) Patent Application Publication
(10) Pub. No.: US 2011/0083414 A1
(43) Pub. Date: Apr. 14, 2011

(54) Lawn-care maintenance apparatus

(76) Inventor: Thomas J. Francis, Clinton Township, MI (US)

(21) Appl. No.: 12/653,777

(22) Filed: Dec. 22, 2009

Related U.S. Application Data
(60) Provisional application No. 61/278,846, filed on Oct. 14, 2009.

(51) Int. Cl. A01D 34/00

(52) U.S. Cl. 56/16.9

(57) ABSTRACT

The lawn-care maintenance apparatus is compatible with a conventional power, self-propelled, walk-behind lawnmower. In one embodiment, the apparatus comprises a rotary blade that can be readily attachable to and detachable from a drive wheel of the power, self-propelled, walk-behind lawnmower. Also, the lawn-care maintenance apparatus comprises fastener elements for securing the rotary blade onto a drive wheel of the power, self-propelled, walk-behind lawnmower. The edger blade when attached to the drive wheel of the power, self-propelled, walk-behind lawnmower is driven by the power system of the self-propelled, walk-behind lawnmower. The rotary blade is offset from the center of the axis of the drive wheel of the self-propelled, walk-behind lawnmower. Another embodiment of the lawn-care maintenance apparatus is a permanent edger attachment that is capped when the edging is not needed, this extending the life of the edger blade. Still another embodiment is a clutch assembly that replaces one of the drive wheels of the power, self-propelled, walk-behind lawnmower, the cutting surfaces of the clutch assembly having an engaged and a retracted position, the cutting surfaces when engaged locking in place and performing the edging.

This Application claims priority from U.S. Provisional Application No. is 61/278,846, entitled “Lawnmower Edger Attachment”, by Thomas J. Francis, filed on Oct. 14, 2009.

### FIELD OF USE

The present invention relates to power, self-propelled, walk-behind lawnmowers, and more particularly, to an apparatus that is compatible with such lawnmowers that performs and selectively is operative to perform the lawn edging function as needed.

### BACKGROUND OF THE INVENTION

Power, self-propelled, walk-behind lawnmowers as shown in FIG. 1, are effective, particularly, where the operator needs to steer and manipulate the lawnmower in uneven or rougher terrains. Once the mowing has been completed to maintain a well manicured lawn, it is then necessary to deploy a separate mechanical edging or trimming device. To overcome the need for an edging device in addition to the lawnmower, it has been proposed to provide bolt-on attachments for mowers that provide the desired edging facility.

To overcome the need for a separate edging device in addition to the lawnmower, various inventions have been made to combine these two devices.
U.S. Pat. No. 5,497,606 (Baxter) discloses a lawnmower with a forward-mounted edger. The improved lawnmower and edging apparatus is a gasoline-powered walk-behind, self-propelled lawnmower, and is provided with an edger mounted on the front of the deck of the lawnmower slightly outside of the track of one of the front wheels. The edger includes a high speed rotating blade that lies in a vertical plane and can be raised to an inoperative position or lowered to an operative position, the power-take-off shaft being substantially parallel to the shaft of the edger.
U.S. Pat. No. 5,966,914 (Reents) discloses a lawnmower-mounted edger, which serves as a weed trimmer. The assembly is hingeably coupled about a horizontal axis to one of the side faces of the lawnmower portion adjacent to a front face. The weed trimmer assembly has a flexible line dispenser for trimming weeds adjacent to the lawnmower when rotated.
U.S. Pat. No. 6,701,700 (Keane) discloses an edge trimmer attachment for a lawnmower. The auxiliary edge trimmer apparatus is attached to the lawnmower and includes a flywheel drive wheel portion connected to the lawnmower drive shaft. An attachment assembly is connected onto portions of the lower housing wall of the blade housing of the lawnmower. Also, angular orientation adjustment structure for the auxiliary trimmer assembly relative to the main rotation shaft axis of the lawnmower are provided to assure control of the width of cut afforded by the auxiliary trimmer.
U.S. Pat. No. 7,516,602 (O'Dell) discloses an attachable trimmer-edger combination for a lawnmower. The trimmer-edger is attached to a conventional lawnmower and uses the lawnmower's power source, and is attached to the front of the lawnmower. A rotatable cable runs from the cutting element to a contact member attached at an opening on the lawnmower housing. A planar disc is located above the conventional grass cutting blade on the same shaft that supports the cutting blade.

None of these devices are optimally designed to perform the edging function in a routine manner.

What is needed is a lawn-care maintenance apparatus that runs off the power system of the self-propelled, walk-behind lawnmower, operating at much lower RPMs than conventional edgers, the slower RPM enabling the user to clear out weeds and debris from expansion joints in walks and driveways easily and safely.

What is needed is a lawn care maintenance apparatus which permits level mowing and edging with the same device, thereby eliminating the need for a separate edging device, that is cost effective to buy and operate and is maintenance free, that is safe to operate, and is powered from the same motor as the “self propelled walk behind” lawnmower.

As such, it may be appreciated that there is a continuing need for a new lawn-care maintenance apparatus wherein the same addresses both the problems of ease of use and effectiveness in organization and the present invention fulfills this need.

### SUMMARY OF THE INVENTION

These and other objects of the invention, which shall be hereafter apparent, are achieved by the lawn-care maintenance apparatus of the present invention.

The lawn-care maintenance apparatus of the present invention can be used for both mowing the lawn and trimming the lawn. The lawn-care maintenance apparatus has a power system and comprises a lawnmower wheel, an edger, and fastener elements for securely mounting the edger to the lawnmower wheel.

The lawnmower wheel is readily mountable onto a lawnmower wheel shaft of a self-propelled, walk-behind lawnmower. The wheel is securely retained on the wheel shaft and is compatible with the other wheels on the lawnmower.

The edger is disk shaped and has a plurality of cutting edges. The edger has symmetrical cutting edges for mounting on either a right lawnmower wheel or a left lawnmower wheel. The edger is driven by the power system of the self-propelled, walk-behind lawnmower. The edger is secured onto a rear wheel of a rear-wheel drive lawnmower or a front wheel of a front-wheel drive lawnmower. One or more fastener elements mount and secure the edger to the lawnmower wheel or to the lawnmower wheel shaft. The edger is mounted onto a drive wheel of said power, self-propelled, walk-behind lawnmower, and, preferably, the edger has an axis that is offset from the axis of the drive wheel that the edger is attached to.

In another preferred embodiment, a cap or cover that is attachable to and removable from the edger covers the cutting edges of the trimmer when trimming is not wanted.

In yet another preferred embodiment, the edger is a clutch assembly that is attachable to and detachable from the lawnmower wheel of the self-propelled, walk-behind lawnmower. The clutch assembly has both an engaged position and a retracted position. The clutch assembly includes a multiplicity of cutting surfaces for edging. The cutting surfaces are retained in a locked position when engaged for edging, and the cutting surfaces are retained in a safe position when retracted.

The lawn-care maintenance apparatus of the present invention can perform an edging of said lawn after said lawn has been being mowed.

It is to be understood that while only embodiments are depicted, the principles of the present invention are equally applicable to many other types of power driven tools.

For a more complete understanding of the lawn-care maintenance apparatus of the present invention, reference is made to the following detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention. Throughout the description, like reference numbers refer to the same component throughout the several views.

### BRIEF DESCRIPTION OF THE DRAWINGS

FIG. 1 discloses a power, self-propelled, walk-behind lawnmower of the prior art.

FIGS. 2A, 2B and 2C disclose a top view, a side view, and a front view of the preferred embodiment of the lawn-care maintenance apparatus of the present invention.

FIGS. 3A and 3B disclose a detailed front view and sectional end view of the preferred embodiment of the of the present invention blade-wheel assembly for the lawn-care maintenance apparatus of FIGS. 2A, 2B, and 2C, respectively.

FIGS. 3C and 3D disclose a detailed front view and sectional end view of the preferred embodiment of the blade-wheel assembly for the lawn-care maintenance apparatus of FIGS. 2A, 2B, and 2C respectively.

FIGS. 4A, 4B, 4C, and 4D disclose four (4) preferred embodiments of the edger blades for use with the lawn-care maintenance apparatus of FIGS. 2A, 2B, and 2C, the blades being double edged and each being mountable on either a left-side or right-side lawnmower wheel.

FIG. 5A is another preferred embodiment of a combination wheel-blade assembly serving as lawnmower and edger assembly for a power self-propelled, walk-behind lawnmower, the blade assembly being retractable when not engaged; and FIG. 5B is a front view of the combination wheel-blade assembly of FIG. 5A in an open and engaged condition.

FIGS. 6A and 6B disclose still another preferred embodiment of the lawn-care maintenance apparatus of the present invention, the detailed front view and sectional end view with a cover extending over the blade when the lawnmower is used for mowing, the cover being removed for edging.

FIG. 7 is a second preferred embodiment disclosing the front-wheel drive lawn-care maintenance apparatus of the present invention—and “Detail A” shows an exploded view of the engagement between the drive wheel and the drive of the lawn-care maintenance apparatus of the present invention.

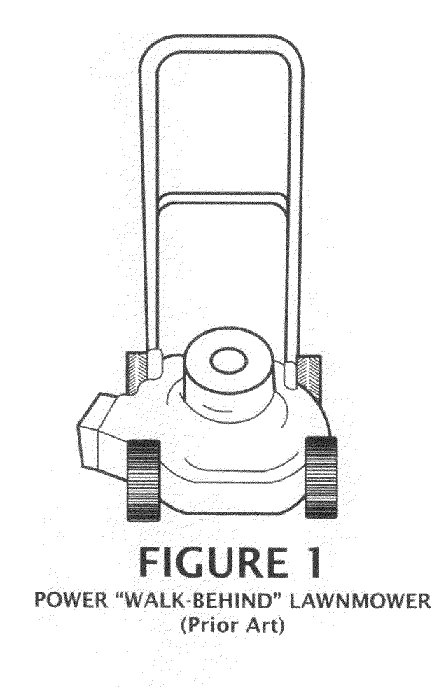

### DETAILED DESCRIPTION OF THE PREFERRED EMBODIMENTS

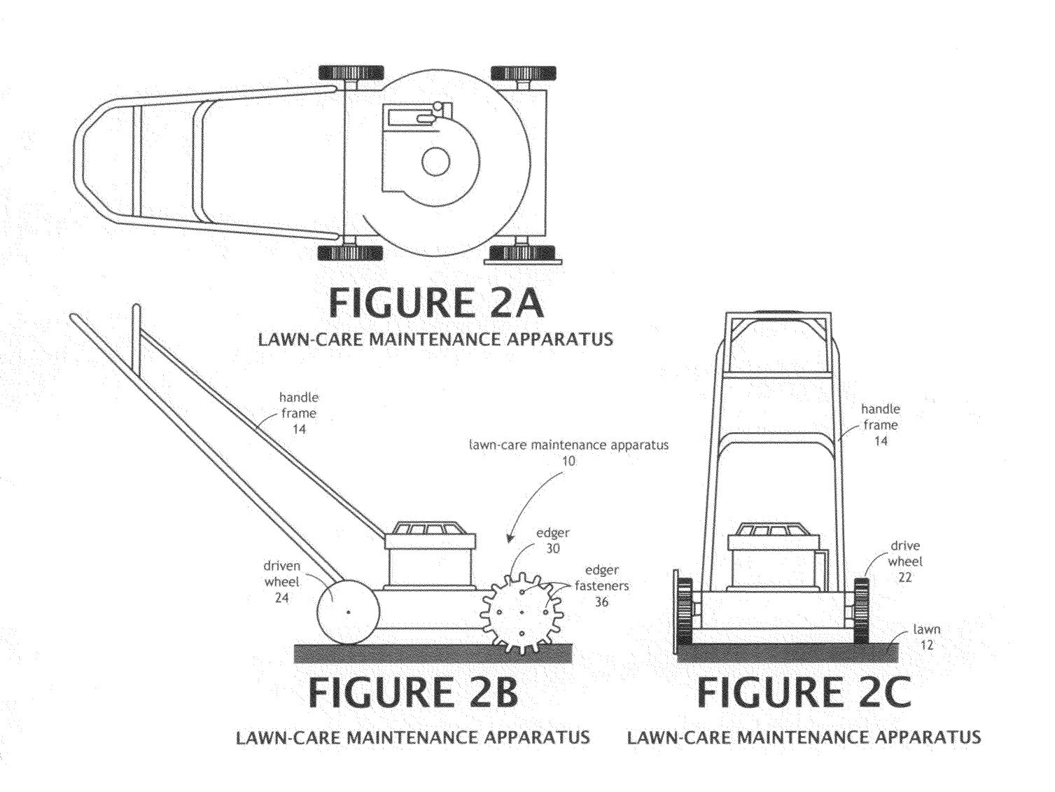

Referring now to the drawings, FIGS. 2A, 2B, and 2C disclose a top view, a side view, and a front view, respectively, of the first preferred embodiments of the lawn-care maintenance apparatus 10 of the present invention. The lawn-care maintenance apparatus 10 includes a handle frame 14 to be held by the operator to maneuver the apparatus, a rolling surface 44 that engages with the lawn 12, a power train 16 that is attached to one of the pair of front drive wheels 22, and a pair of rear driven wheels 24. The lawn-care maintenance apparatus 10 of the present invention can be used for both mowing and edging the lawn 12.

The lawn-care maintenance apparatus 12 comprises a lawnmower wheel 22, an edger 30, and fastener elements 36 for securely mounting the edger to the lawnmower drive wheel 22.

The lawnmower wheel is readily mountable onto a lawnmower wheel shaft 46 of a self-propelled, walk-behind lawnmower. The lawnmower wheel is securely retained on the wheel shaft 46 and is compatible with the other drive and driven wheels on the lawnmower.

The edger 30 is disk shaped and has a plurality of cutting edges 34. The edger 30 preferably has symmetrical cutting edges for mounting on either a right lawnmower wheel or a left lawnmower wheel to accommodate lawnmower operators that are either right or left-handed, and also to enable the apparatus of the present invention to be useful in various environments. Also, the symmetry extends the life of the edger 30. The edger 30 is driven by the power train 16 of the self-propelled, walk-behind lawnmower. Preferably, the edger 30 is secured onto a rear wheel of a rear-wheel drive lawnmower or a front wheel of a front-wheel drive lawnmower. In the preferred embodiment, the cutting edges of the rotating edger 30 are normal to the rolling surface 44, ±20°.

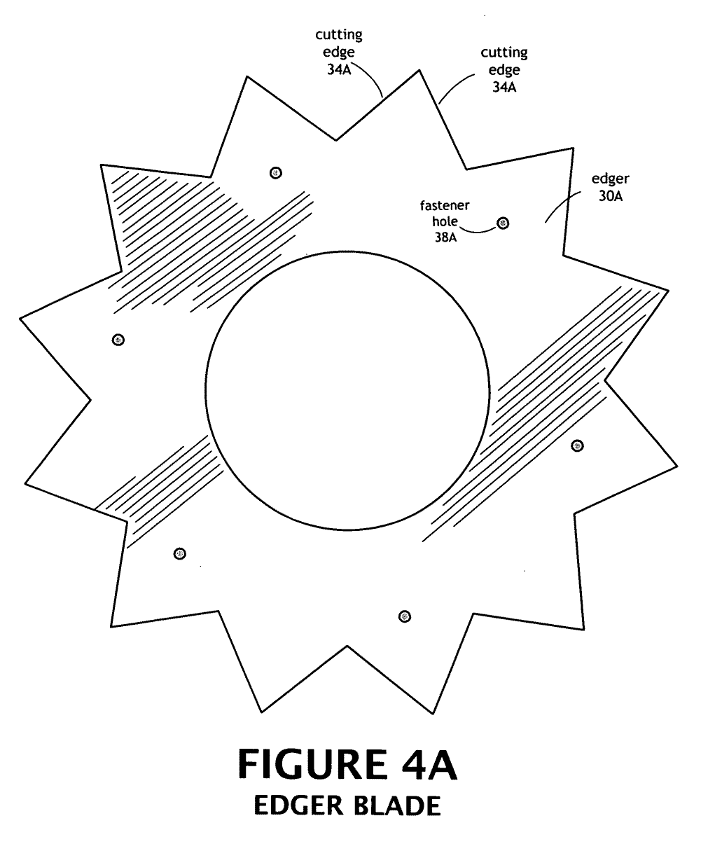

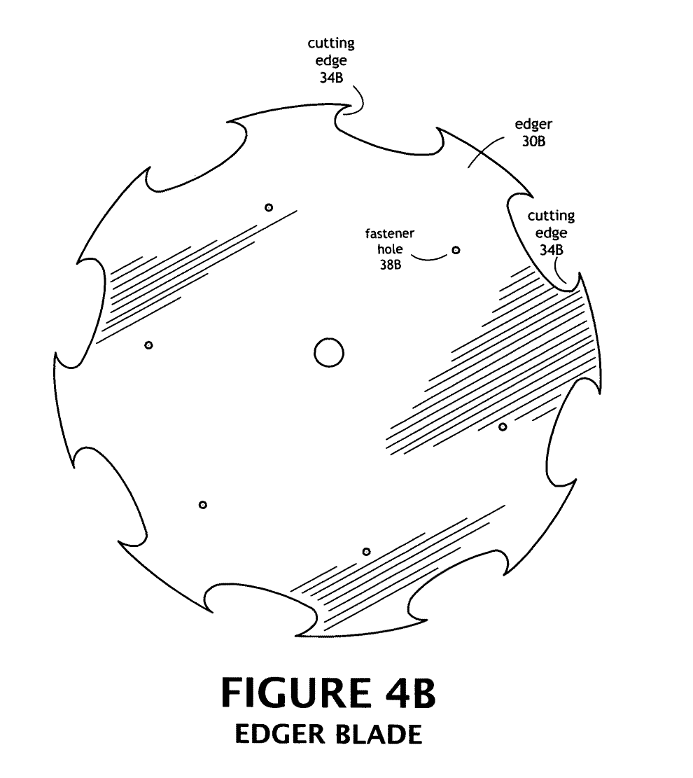

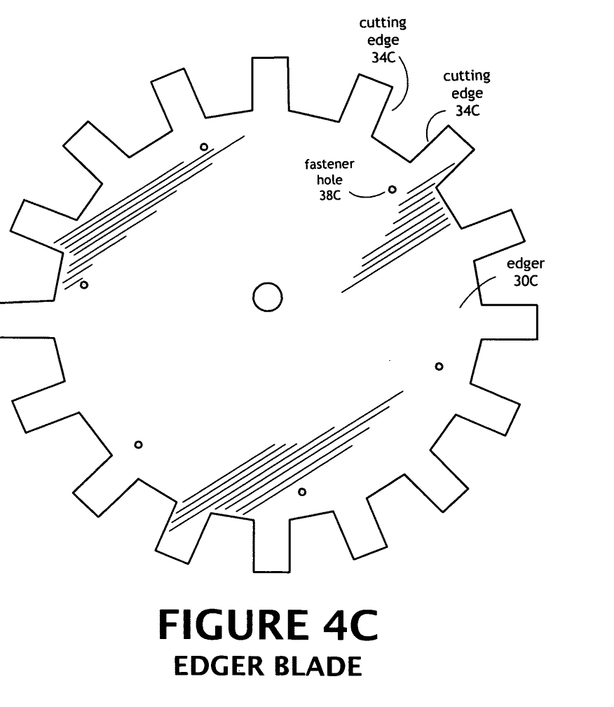

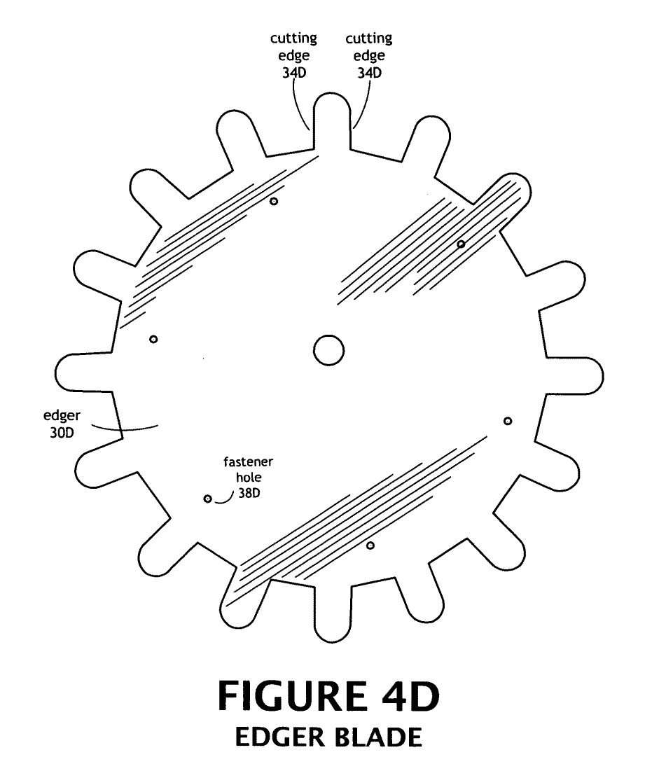

FIGS. 4A, 4B, 4C, and 4D disclose four (4) preferred embodiments of the edger blades for use with the lawn-care maintenance apparatus of FIGS. 2A, 2B, and 2C. Each of the blades are double edged and can be mount on either a left-side or right-side lawnmower wheel. Once the lawnmower has completed mowing the lawn, the edger is attached to a lawnmower wheel with conventional fasteners and the lawn is then edged.

One or more edger fasteners 36 mount and secure the edger 30 to the drive wheel 22. In an alternate embodiment (not shown), the edger fasteners 36 mount and secure the edger 30 to the wheel shaft 46. The fastener elements 36 comprise, for example, one or more bolts, j-bolts, screws, nuts, magnets, body clips, pins rivets washers, or any combination of such fasteners to secure the edger to the wheel or the wheel axle. Adhesives or welding may also be used.

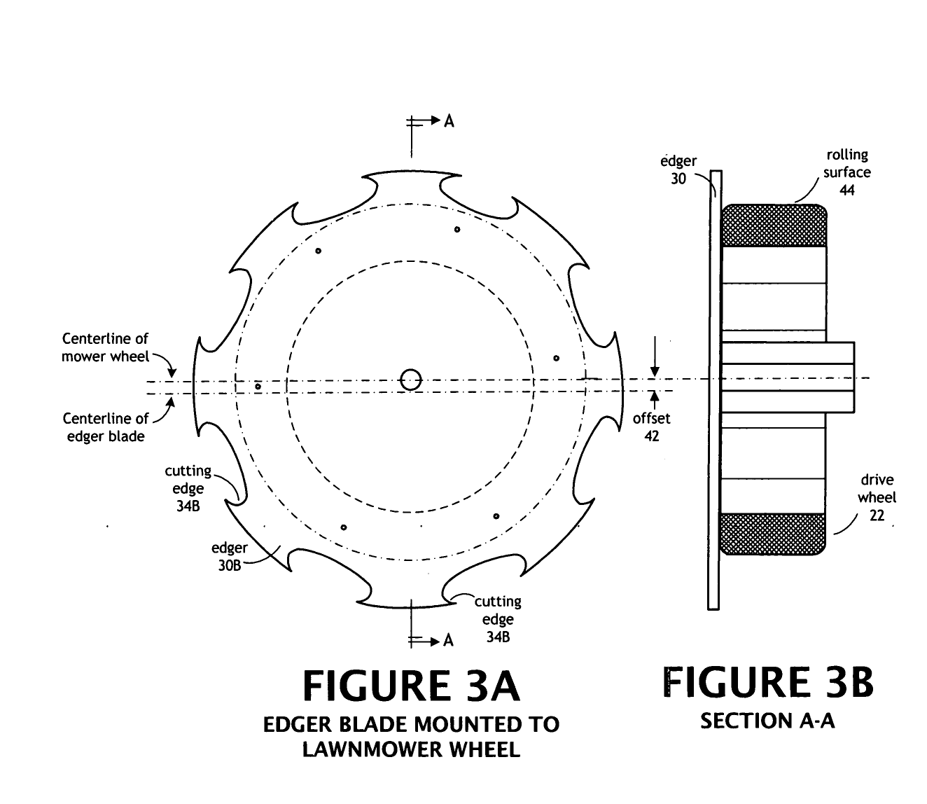

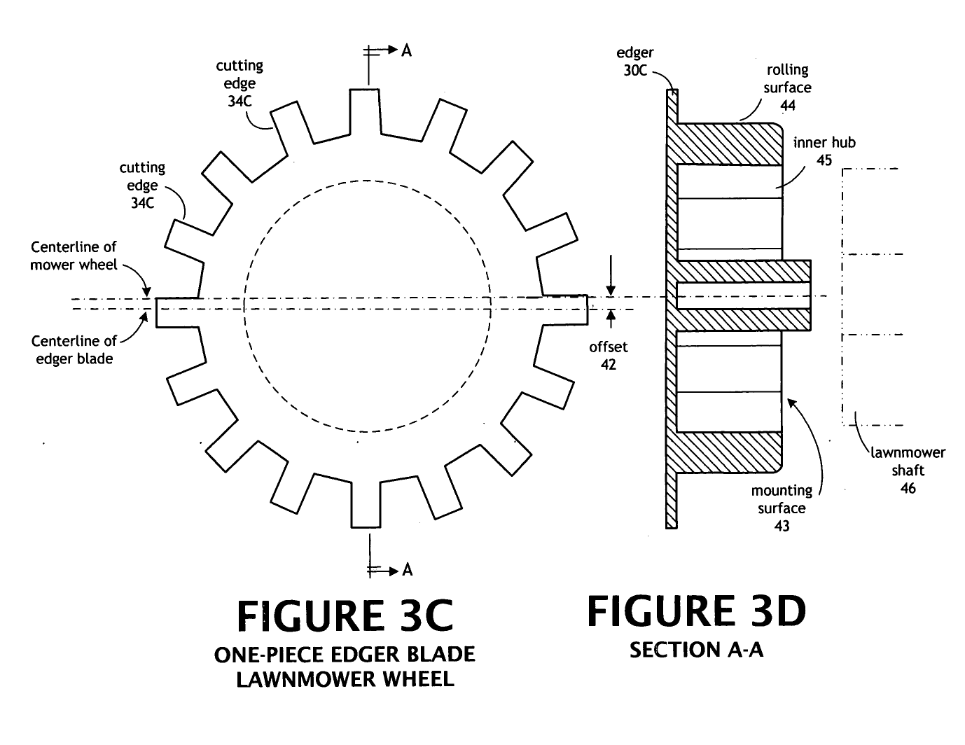

It has been found that the edger blade preferably has a 10 inch diameter with a tolerance of ±¾ inches, for an 8 inch diameter lawnmower wheel. The edger blade of FIG. 4A is coaxial with the drive wheel 22. However, for the edger blade configurations shown in FIGS. 4B, 4C, and 4D, having a larger number of cutting edges 34, the preferred embodiment of the lawn-care maintenance apparatus of the present invention is the edger 30 extending ½ inch beyond the top of the drive wheel 22, and ½ inch beyond the bottom of the drive wheel 22, as shown in FIGS. 3A and 3B. This is necessary to overcome drag forces caused by grass build-up on the cutting edges 34. The centerline of the edger 30 is offset about ¼ inches from the centerline of the drive wheel 22, with a tolerance of ±¼ inches.

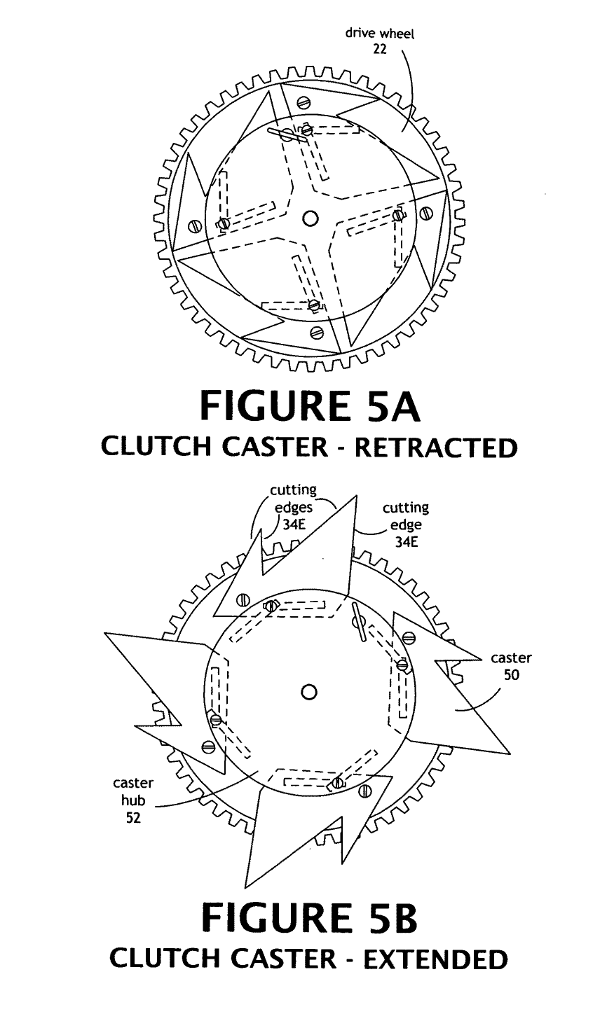

Referring now to FIGS. 5A and 5B, of the lawn-care maintenance apparatus 10 is shown. The lawn-care maintenance apparatus is an assembly of edger blades in a clutch-type configuration, the blade assembly being attachable to and detachable from, again, the drive wheel 22 of the self-propelled, walk-behind lawnmower. The blade assembly has both an engaged position and a retracted position. The blade assembly includes four casters 50, each caster mounted about a caster hub 52. The cutting edges 34E blades are double edged and can be mounted on either the right or left side of the lawnmower. The cutting edges 34E are retained in a locked position when engaged for edging. The cutting edges 34E are retained in a safe position when retracted. When engaged, the caster cutting edges 34E protrude from the wheel housing for edging and retract during the mowing function. The control mechanism for this blade assembly is retained in the grip of the handle frame 14 (not shown).

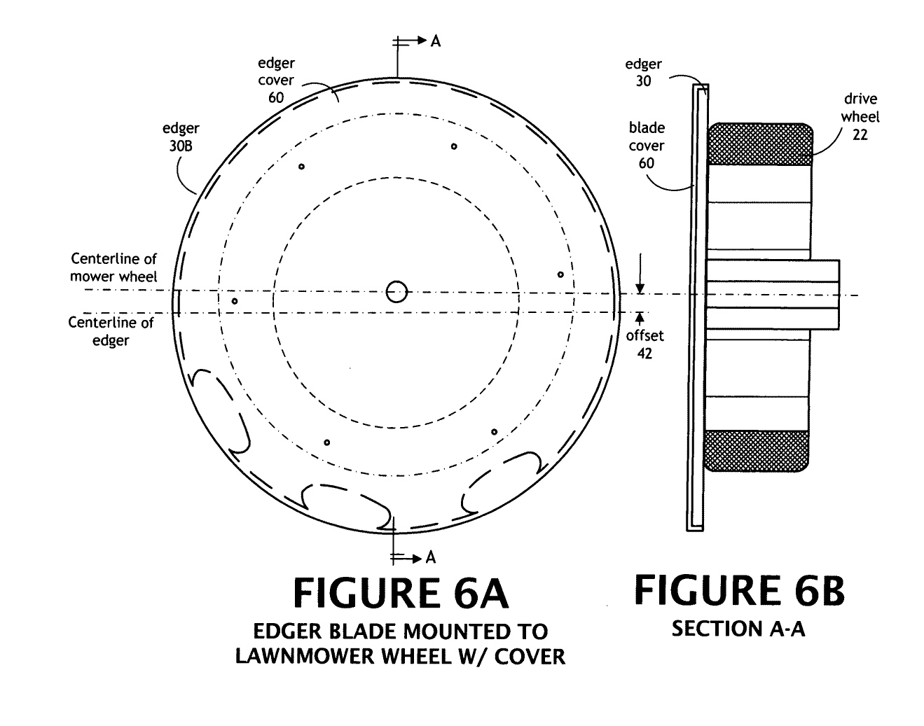

Referring now to FIGS. 6A and 6B, another preferred embodiment of the lawn-care maintenance apparatus 10 is shown. An edger cover 60 is attachable to and removable from the edger 30 covering the cutting edges 34 of the edger 30 when edging is not wanted. The edger 30 may be permanently secured to the drive wheel 22 or even integral therewith (see FIGS. 3C and 3D). The edger cover 60 is affixed about the edger 30 during mowing, preferably at or near the center of the edger 30, and the edger cover 60 is removed during the edging operation.

The lawn-care maintenance apparatus 10 of the present invention can perform an edging of the lawn 12 after the lawn 12 is mowed. Once the lawn 12 is mowed, the edger 30 is attached to one of the drive wheels 22 with edger fasteners 36.

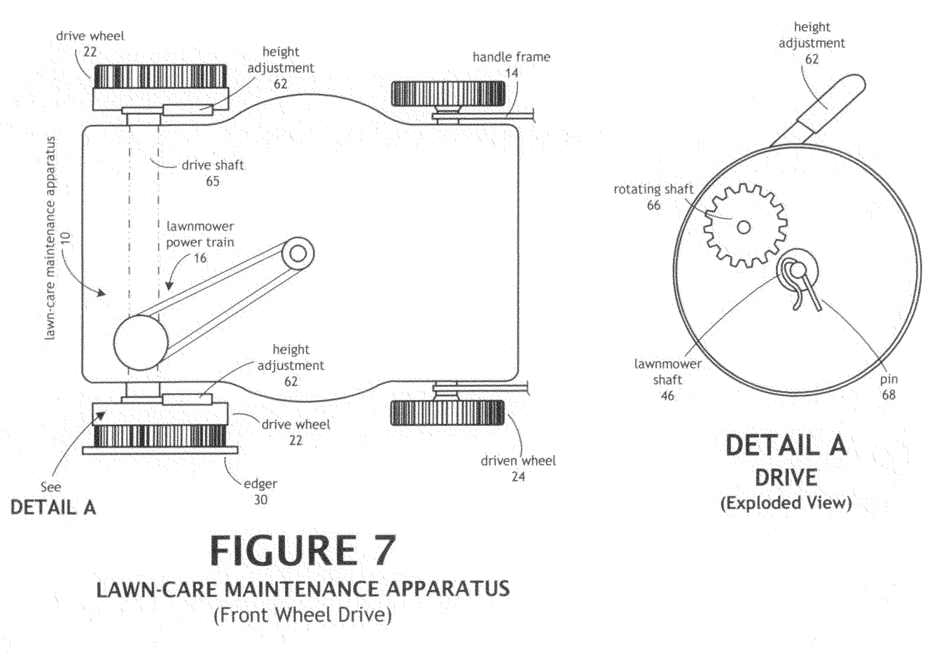

Referring now to FIG. 7, a second preferred embodiment of the lawn-care maintenance apparatus of the present invention is disclosed—a front-wheel drive lawnmower being shown. The lawnmower power train 16 is mechanically engaged to the front wheel drive shaft 65. A rotating shaft 66 extends into the inner hub of the drive wheel 22. The drive wheel 22 is affixed to the lawnmower shaft 46 and held in place with a cotter pin 68, or the like (see “Detail A”). The edger 30 is then mounted onto the drive wheel 22 of the drive shaft 65 of the power, self-propelled, walk-behind lawnmower. An adjustment 62 enables the height of either drive wheel to be positioned relative to the lawnmower.

The edger 30 is preferably mounted onto a drive wheel 22 of said power self-propelled, walk-behind lawnmower. In the preferred embodiment, the edger 30 has an axis that is offset from the axis of the drive wheel 22 that the edger 30 is attached to. This also makes mowing easier and reduces wear and tear on the mower power train 16.

Referring now to FIGS. 3C and 3D, yet still another preferred embodiment of the lawn-care maintenance apparatus 10 of the present invention is disclosed. The edger 30 and drive wheel are one-piece. After the lawn 12 has been completely mowed, a conventional drive wheel is installed on the lawnmower as a replacement.

The edger blade of the present invention has an RPM of between 110 to 160 RPMs. The blade speed in most conventional edging systems is 1750 to 2500 RPM to the blade. The slower RPM enables the user to clear out weeds and debris from expansion joints in walks and driveways easily and safely.

The edger blade of the present invention is preferably has carbon teeth, with between 6 and 36 teeth evenly distributed about the circumference of the blade, and preferably, between 10 and 20.

While the drawings show the center line of the edger blade offset from the center line of the lawnmower wheel, another preferred embodiment which is not shown has the two center lines in alignment.

The lawn-care maintenance apparatus attachment of the present invention runs off a power system of a self-propelled, walk-behind lawn mower. The adjustment is preferably attached to the rear wheel of a rear-wheel drive lawnmower, and the front wheel of a front-wheel drive lawnmower.

Throughout this application, various patents are referenced by number. The disclosures of these patents in their entireties are hereby incorporated by reference into this specification in order to more fully describe the state of the art to which this invention pertains.

It is evident that many modifications and variations of the lawn-care maintenance apparatus will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10 lawn-care maintenance apparatus
12 lawn
14 handle frame
16 power train
22 drive wheel
24 driven wheel
30 edger
34 cutting edge
36 edger fasteners
38 fastener hole
40 blade-wheel
42 offset
43 mounting surface
44 rolling surface
45 inner hub
46 shaft
50 caster
52 caster hub
60 edger cover
62 height adjustment
65 drive shaft
66 rotating shaft
68 pin

1. An apparatus for maintaining and caring for a lawn having a power system, said lawn-care apparatus comprising:
(a) a mounting surface that is readily attachable onto a lawnmower wheel shaft of a self propelled walk-behind lawnmower, the mounting surface having a rolling surface that rolls upon said lawn onto which said self propelled walk-behind lawnmower is to mow; and
(b) an edger having a plurality of cutting edges, said edger being affixed and securely retained with said mounting surface relative to said wheel shaft;
wherein said edger is driven by the power system of said self propelled walk-behind lawnmower; and
wherein said apparatus can perform an edging of said lawn after said lawn has been mowed.

2. The lawn-care apparatus of claim 1, whereby said edger whereby said edger is mounted onto a drive wheel of the power self propelled walk-behind lawnmower, the edger being secured onto a rear wheel of a rear-wheel drive lawnmower or a front wheel of a front-wheel drive lawnmower.

3. The lawn-care maintenance apparatus of claim 1, further comprising an edger cover that is attachable to and removable from said edger, protecting said cutting edges during mowing when edging is not wanted.

4. The lawn-care maintenance apparatus of claim 1, whereby said edger has symmetrical cutting edges for mounting on either a right mounting surface or a left mounting surface.

5. The lawn-care maintenance apparatus of claim 1, whereby said cutting edges of said edger and said rolling surface are at an angle ranging between 70° to 110°.

6. The lawn-care maintenance apparatus of claim 1, whereby said edger has an axis that is offset from an axis of said drive wheel of the self propelled walk-behind lawnmower.

7. The lawn-care maintenance apparatus of claim 1, whereby the edger is a clutch assembly being attachable to and detachable from said lawnmower wheel of said self propelled walk-behind lawnmower, said clutch assembly having an engaged position and a retracted position, said clutch assembly including a multiplicity of cutting surfaces in the engaged position for edging, said cutting surfaces being retained in a locked position when engaged for performing edging, said cutting surfaces being retained in a safe position when retracted.

8. A lawn-care maintenance apparatus having a power system, said lawn-care maintenance apparatus comprising:
(a) a lawnmower wheel that is readily mountable onto a lawnmower wheel shaft of a self propelled walk-behind lawnmower;
(b) an edger having a plurality of cutting edges; and
(c) one or more fastener elements for mounting and securing said edger to said lawnmower wheel or to said lawnmower wheel shaft;
wherein the edger is driven by the power system of the self propelled walk-behind lawnmower;
wherein said lawn-care maintenance apparatus can perform an edging of said lawn after said lawn has being mowed.

9. The lawn-care maintenance apparatus of claim 8, whereby said edger whereby said edger is mounted onto a drive wheel of the power system of a self propelled walk-behind lawnmower, the edger being secured onto a rear wheel of a rear-wheel drive lawnmower or a front wheel of a front-wheel drive lawnmower.

10. The lawn-care maintenance apparatus of claim 8, further comprising an edger cover that is attachable to and removable from said edger, protecting said cutting edges during mowing when edging is not wanted.

11. The lawn-care maintenance apparatus of claim 8, whereby said edger has symmetrical cutting edges for mounting on either a right lawnmower wheel or a left lawnmower wheel.

12. The lawn-care maintenance apparatus of claim 8, whereby said cutting edges of said edger and said rolling surface are at an angle ranging between 70° to 110°.

13. The lawn-care maintenance apparatus of claim 8, whereby said edger has an axis that is offset from an axis of the drive wheel of said self propelled walk-behind lawnmower.

14. The lawn-care maintenance apparatus of claim 8, whereby said edger is a clutch assembly being attachable to and detachable from said lawnmower wheel of the self propelled walk-behind lawnmower, said clutch assembly having an engaged position and a retracted position, said clutch assembly including a multiplicity of cutting surfaces in said engaged position for edging, said cutting surfaces being retained in a locked position when engaged for edging, said cutting surfaces being retained in a safe position when retracted.

15. A lawn-care maintenance apparatus having a power system, said lawn-care maintenance apparatus comprising:
(a) a lawnmower wheel that is readily mountable onto a lawnmower wheel shaft of a self propelled walk-behind lawnmower, said lawnmower wheel being secured onto a rear wheel of a rear-wheel drive lawnmower or a front wheel of a front-wheel drive lawnmower;
(b) an edger having a plurality of cutting edges; and
(c) one or more fastener elements for mounting and securing said edger to said lawnmower wheel or to said lawnmower wheel shaft: and
wherein the edger is driven by the power system of the self propelled walk-behind lawnmower;
wherein said lawn-care maintenance apparatus can edge said lawn after said self propelled walk-behind lawnmower has mowed said lawn; and
wherein said edger has an axis that is offset from the axis of the lawnmower wheel of the self propelled walk-behind lawnmower upon which it is mounted.

16. The lawn-care maintenance apparatus of claim 15, further comprising an edger cover that is attachable to and removable from said edger, protecting said cutting edges during mowing when edging is not wanted.

17. The lawn-care maintenance apparatus of claim 15, whereby said edger has symmetrical cutting edges for mounting on either a right lawnmower wheel or a left lawnmower wheel.

18. The lawn-care maintenance apparatus of claim 15, whereby said edger is mounted onto a drive wheel of said power self propelled walk-behind lawnmower.

19. The lawn-care maintenance apparatus of claim 15, whereby said edger is a clutch assembly being attachable to and detachable from said lawnmower wheel of the self propelled walk-behind lawnmower, said clutch assembly having an engaged position and a retracted position, said clutch assembly including a multiplicity of cutting surfaces in said engaged position for edging, said cutting surfaces being retained in a locked position when engaged for edging, said cutting surfaces being retained in a safe position when retracted.

20. The lawn-care maintenance apparatus of claim 15, whereby said edger can be disengaged from said lawnmower wheel, enabling said lawn-care maintenance apparatus to operate as a self propelled walk-behind lawnmower.
